(19) United States
(12) Patent Application Publication
(10) Pub. No.: US 2016/0000624 A1
(43) Pub. Date: Jan. 7, 2016

(54) APPARATUS FOR PREVENTING BEDSORES

(71) Applicants: Sue Min CHO, Yongin (KR); Myongchol JUNG, Seongnam (KR); Kwanwoo YOON, Gangneung (KR)

(72) Inventors: Sue Min CHO, Yongin (KR); Myongchol JUNG, Seongnam (KR); Kwanwoo YOON, Gangneung (KR)

(21) Appl. No.: 14/468,581

(22) Filed: Aug. 26, 2014

(30) Foreign Application Priority Data
Jul. 2, 2014 (KR) 10-2014-0082414

(51) Int. Cl. A61G 7/057; A61G 7/015

(52) U.S. Cl. CPC A61G 7/0573; A61G 7/015; A61G 2200/32

(57) ABSTRACT

An apparatus for preventing bedsores is disclosed. The apparatus includes a sub-frame, a main frame, a right arm lifting unit, a left leg lifting unit, a side block lifting unit, and a sub-frame tilting unit. The sub-frame includes a center block and a central shaft. The main frame surrounds and supports the sub-frame. The right arm lifting unit is supported by the sub-frame below the right arm lifting block. The left leg lifting unit is supported below the left leg lifting block by the sub-frame. The side block lifting unit is supported below the right block by the sub-frame. The sub-frame tilting unit includes a first gear, a second gear, a chain, and a first gear driving motor.

### BACKGROUND OF THE INVENTION

1. Field of the Invention

The present invention relates generally to an apparatus for preventing bedsores and, more particularly, to an apparatus for preventing bedsores, which changes the lying position of a patient in order to prevent bedsores that frequently occur in a patient who has lain for a long time.

2. Description of the Related Art

Healthy humans do not lie on a bed for a long time, whereas ill or unhealthy humans or patients need to lie on a bed for a long time. In the case of such a human who needs to have lain on a bed for a long time, bedsores easily occur because the portion of the human body that comes into contact with a bed has been pressed by the weight of the human body for a long period of time, and thus the circulation of blood is not well accomplished. When bedsores occur, additional health concerns, such as other complications and side effects, are incurred by patients.

Accordingly, Korean Patent No. 10-0732559 discloses a bed structure which is capable of preventing bedsores. In this patent, the mattress of the bed is configured to be divided into multiple blocks, and an electric cylinder is disposed perpendicular to the ground below each of the blocks. The electric cylinder functions to selectively move the block of the mattress up and down. The height of the block varies as the block is moved, and thus the differences in the height of the surface of the bed occur with respect to the respective blocks. The pressed part of the body of a patient may be changed due to these differences, and furthermore the position of the body of the patient is also tilted at a predetermined angle.

In accordance with the bed for preventing bedsores, differences in height between the individual blocks occur through the action of the multiple blocks and electric cylinders constituting the mattress of the bed, and both ventilation as well as the circulation of blood is well accomplished by the release of the pressed portion of the body thanks to these differences.

However, since the above-mentioned bed for preventing bedsores frequently changes only the pressed portion of the body of the patient while maintaining a basic position where a patient lies, the fatigue, drag and stress of the patient attributable to the maintenance of the basic position may still remain from the perspective of the patient. Furthermore, unless a basic lying position is changed (for example, unless the basic lying position is changed from a position where the patient lies while looking at a ceiling to another position where the patient lies laterally), ventilation for the back portion of the patient is not entirely accomplished, and thus it is difficult to achieve the effect of sufficient blood circulation and ventilation.

Accordingly, a technology for overcoming the aforementioned problem has been required.

Meanwhile, the above-described related technology is previously held by the inventor and has led to the inception of the present invention, and serves as an integral aspect of the corresponding technical information acquired in the process of contriving the present invention. This technology is not necessarily considered to be well-known technology disclosed to the general public prior to the application of the present invention is filed.

### SUMMARY OF THE INVENTION

Accordingly, the present invention has been made keeping in mind the above problems occurring in the prior art, and an object of the present invention is to provide an apparatus for preventing bedsores, which is capable of changing the basic position of a patient who has lain on a bed, thereby preventing bedsores.

In accordance with an aspect of the present invention, there is provided an apparatus for preventing bedsores, including a sub-frame including a center block configured to include a right arm lifting block and a left leg lifting block that are installed, respectively, at locations corresponding to a right arm and left leg of a lying patient if a body of the lying patient is disposed, and a central shaft configured to correspond to a length of a left block, a right block and a center block in longitudinal directions thereof that are connected in order to be bent from both side surfaces of the center block with respect to the center block, and installed along a center of the center block; a main frame configured to surround and support the sub-frame; a right arm lifting unit supported below the right arm lifting block by the sub-frame, the right arm lifting unit including a first circular rotator disposed to come into contact with a bottom of the right arm lifting block, a first connecting member connected to an noncentral region of the first circular rotator that is away from a center of a circle of the first circular rotator, and a first driving motor configured to rotate the first connecting member in place so that the first circular rotator pushes and raises the right arm lifting block and, thus, the right arm lifting block is protruded above a top of the center block; a left leg lifting unit supported by the sub-frame below the left leg lifting block, the left leg lifting unit including a second circular rotator disposed to come into contact with a bottom of the left leg lifting block, a second connecting member connected to an noncentral region of the second circular rotator that is away from the center of the circle of the second circular rotator, and a second driving motor configured to rotate the second connecting member in place so that the second circular rotator pushes and raises the left leg lifting block and, thus, the left leg lifting block is protruded above the top of the center block; a side block lifting unit supported below the right block by the sub-frame, the side block lifting unit including a third circular rotator disposed to be spaced apart from a bottom of the right block, a side block link configured such that one end thereof is connected to an noncentral region of the third circular rotator that is away from a center of a circle of the third circular rotator and a remaining end thereof is connected to a bottom of the right block, and a third driving motor configured to rotate the third circular rotator in place so that the side block link pushes and raises the right block and, thus, the right block is bent at a predetermined angle toward the center block; and a sub-frame tilting unit including a first gear installed in a lower portion of the main frame, a second gear installed in an upper portion of the main frame and connected with the central shaft of the sub-frame, a chain configured to connect the first and second gears so that rotation of the first gear in place causes rotation of the second gear in place, and a first gear driving motor configured to rotate the first gear in place so that the right arm lifting block, the left leg lifting block and the right block tilt the sub-frame, which have been pushed and raised, at a predetermined angle in such a manner that the second gear rotates the central shaft of the sub-frame at a predetermined angle.

The first driving motor may rotate the first connecting member in place at a first angle in one direction so that the first circular rotator moves upward while rotating and, thus, pushes and raises the right arm lifting block; and may rotate the first connecting member in place at a second angle in one direction so that first circular rotator that has pushed and raised the right arm lifting block moves downward while rotating and, thus, returns to an initial location.

The second driving motor may rotate the second connecting member in place at a third angle in one direction so that the second circular rotator moves upward while rotating and, thus, pushes and raises the left leg lifting block; and may rotate the second connecting member in place at a fourth angle in one direction so that the second circular rotator that has pushed and raised the left leg lifting block moves downward while rotating and, thus, returns to an initial location.

Each of the first and second circular rotators may include a plurality of circular plates spaced apart from each other and disposed in parallel with each other; and a plurality of plate connecting members configured to connect a plurality of circular plates.

The first and second circular rotators may be disposed such that the curved surface of the plurality of circular plates comes into contact with the bottom of the left leg lifting block or the bottom of the right arm lifting block.

The apparatus for preventing bedsores may further include a right arm mattress attached to a top of the right arm lifting block; and the right arm mattress may be configured to be thicker than a mattress attached to the top of the center block exclusive of the right arm lifting block.

The right arm mattress may have a difference in height so that a mattress area corresponding to an arm of the lying patient is higher than a mattress area corresponding to shoulders of the lying patient.

The left leg lifting block may include a plurality of sub blocks connected in order to be bent with respect to each other; and the plurality of sub blocks may be connected in order to be bent with respect to each other at a predetermined angle when being pushed and raised upward by the second circular rotator.

The left leg lifting unit may be installed in the sub-frame in order to be moved along lines corresponding the left leg lifting block.

The side block lifting unit may be configured to push and raise the right block so that an angle at which the right block is bent is an acute angle.

The sub-frame tilting unit may be configured to tilt the sub-frame so that the right block is lowered below the left block.

The apparatus may further include a supporting member configured such that an upper end thereof is connected with the sub-frame and a lower end thereof is connected with the main frame so that the sub-frame is assisted in being tilted and fixed at a predetermined angle.

### BRIEF DESCRIPTION OF THE DRAWINGS

The above and other objects, features and advantages of the present invention will be more clearly understood from the following detailed description taken in conjunction with the accompanying drawings, in which:

FIG. 1 is a perspective view of an apparatus for preventing bedsores according to an embodiment of the present invention;

FIG. 2 is a perspective view of the sub-frame of the apparatus for preventing bedsores according to an embodiment of the present invention;

FIG. 3 is a perspective view of the right and left leg lifting units of the apparatus for preventing bedsores according to an embodiment of the present invention;

FIGS. 4A and 4B are side views illustrating the operation of the right arm lifting unit of the apparatus for preventing bedsores according to an embodiment of the present invention;

FIGS. 5A and 5B are side views illustrating the operation of the left leg lifting unit of the apparatus for preventing bedsores according to an embodiment of the present invention;

FIG. 6 is a perspective view of the side block lifting unit of the apparatus for preventing bedsores according to an embodiment of the present invention;

FIGS. 7A and 7B are front views illustrating the operation of the side block lifting unit of the apparatus for preventing bedsores according to an embodiment of the present invention; and

FIG. 8 is a rear view illustrating the structure of the sub-frame tilting unit of the apparatus for preventing bedsores according to an embodiment of the present invention.

### DESCRIPTION OF THE PREFERRED EMBODIMENTS

Embodiments of the present invention will be described in detail with reference to the accompanying drawings below so that a person having ordinary knowledge in the art to which the present invention pertains can easily practice the present invention. However, the present invention may be implemented in various different forms, and is not limited to the embodiments described herein. Parts unrelated to the detailed description are omitted in the drawings in order to clearly describe the present invention, and like reference numerals are assigned to like components throughout the specification.

Throughout the specification and claims, when a component is described as “including” or “comprising” another component, this implies that the first component may include one or more additional unmentioned components, rather than excluding these components.

The present invention is described in detail below with reference to the accompanying drawings.

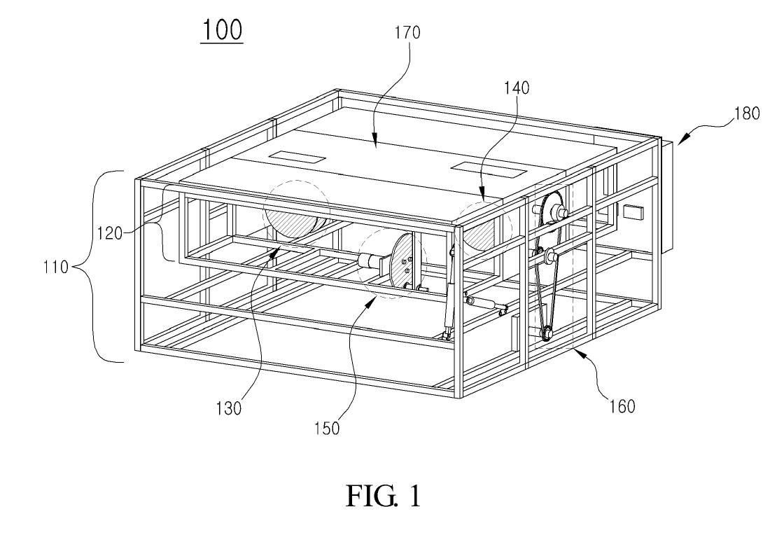

FIG. 1 is a configuration diagram illustrating an apparatus 100 for preventing bedsores according to an embodiment of the present invention.

The apparatus 100 for preventing bedsores according to the present embodiment of the present invention includes a main frame 110, a sub-frame 120, a right arm lifting unit 130, a left leg lifting unit 140, a side block lifting unit 150, a sub-frame tilting unit 160, a mattress 170, and a control unit 180.

The main frame 110 is configured to surround and support the sub-frame 120. The main frame 110 is configured in the form of a regular hexahedron frame, and may further include a additional frame for supporting the sub-frame 120 in the inside thereof.

The sub-frame 120 functions to change the position of a patient lying on a mattress 170 in order to prevent bedsores. The sub-frame 120 is also configured in the form of a regular hexahedron frame, and is supported in the main frame 110. The structure of the sub-frame 120 may be divided into an upper structure and a lower structure. The upper structure of the sub-frame 120 is configured in the form of a block to which the mattress 170 is attached, and may be generally divided into two side blocks and a center block. In this case, a location where a lying patient is placed may correspond to the area of the center block. The function of changing the position of a patient may be performed by bending or tilting some of the three blocks. The lower structure of the sub-frame 120 may include a frame structure that supports and holds the right arm lifting unit 130, the left leg lifting unit 140, and the side block lifting unit 150.

The right arm lifting unit 130 performs the single pattern operation of selectively raising and lowering a right arm lifting block disposed in a center block 121. In this case, the right arm of the patient lying on the center block is raised at a predetermined angle with respect to the surface of the mattress 170 by the right arm lifting unit 130.

The left leg lifting unit 140 is configured to perform the single pattern operation of selectively raising and lowering a left leg block disposed on the center block 121. In this case, the left leg of the patient disposed on the center block 121 is raised at the predetermined angle with respect to the surface of the mattress 170 by the left leg lifting unit 140.

The side block lifting unit 150 is configured to bend a side block of the three blocks of the sub-frame 120 upward at a predetermined angle with respect to the surfaces of the other remaining blocks. The side block that has been bent upward functions as a support that prevents a patient from falling onto a floor when the position of the patient has been changed.

The sub-frame tilting unit 160 is configured to tilt the sub-frame 120, and functions to rotate the central shaft of the sub-frame 120, thereby tilting the sub-frame 120 at the predetermined angle in one direction. The sub-frame tilting unit 160 is installed in an area of the main frame 110. The sub-frame tilting unit 160 tilts the sub-frame 120 so that the side block bent upward is disposed below the side block that has not been bent, and thus the position of the patient who is lying while looking at a ceiling may be changed to a position in which the patient can look to his or her side.

The control unit 180 is configured to control the operations of the right arm lifting unit 130, the left leg lifting unit 140, the side block lifting unit 150 and the sub-frame tilting unit 160 that are described above. In accordance with the operations of the respective components, the step of preventing bedsores may be divided into 1) the step of raising a right arm and a left leg, 2) the step of raising the side block, 3) the step of tilting the sub-frame 120, and 4) the step of initializing a current state as an original state. The control unit 180 may control the operations of these steps. The control unit 180 includes buttons for operating the respective steps, and the patient may control the operations by pushing the buttons for the respective steps.

That is, the apparatus 100 for preventing bedsores according to an embodiment of the present invention may change the overall position of the patient by changing the position (hereafter referred to as a “first position”) of the patient who lies while looking at the ceiling to the position (hereafter referred to as a “second position”) in which the eyes of patient are directed toward his or her side so that a shoulder of the patient comes into contact with the mattress 170. Accordingly, the patient is released from pressure, applied to the overall portions of the patient, such as the back, waist, hips and legs of the patient, at one time when the patient lies while looking at the ceiling, thereby improving blood circulation and ventilation.

The individual components of the apparatus 100 for preventing bedsores are described in greater detail below.

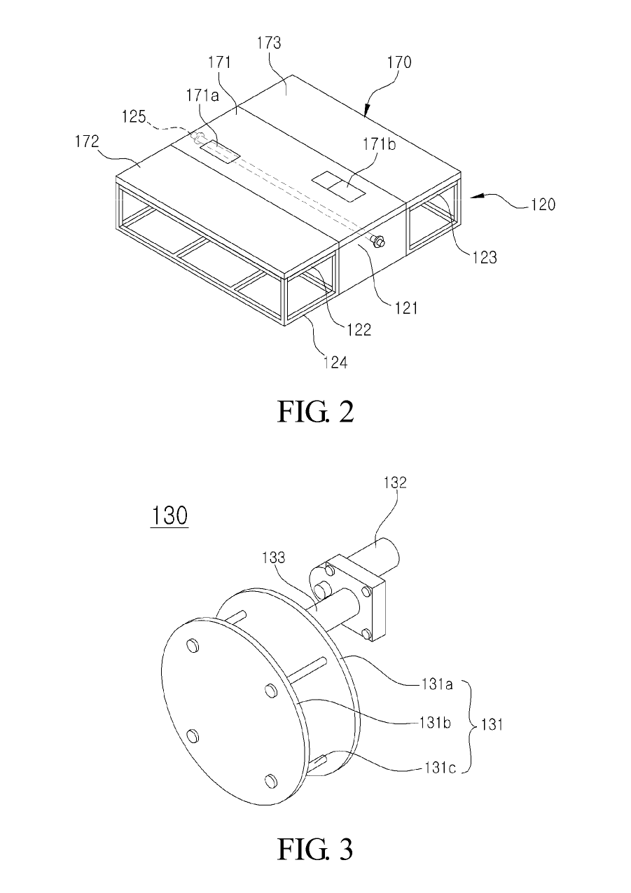

Referring to FIG. 2, the sub-frame 120 according to an embodiment of the present invention includes an upper structure, a lower structure, and a central shaft. The upper structure includes the center block 121, a right block 122, and a left block 123. Each of the blocks includes plates made of steel or plastic, and the blocks may be connected by connecting members (not illustrated) in order to be bent with respect to each other. Furthermore, the mattress 170 is attached to the tops of the blocks, and may be also divided into the center mattress 170, a right side mattress 172, and a left side mattress 173. In this case, the center block 121 includes a right arm lifting block 121a, and a left leg lifting block 121b. Although hidden by the mattress 170 and not illustrated in the drawing, the area where the right arm lifting mattress 170 and the left leg lifting mattress 170 are disposed corresponds to the area where the right arm lifting block 121a and the left leg lifting block 121b are disposed. The right arm lifting block 121a and the left leg lifting block 121b are blocks that operate independently of the center block 121 and that are raised and lowered by the right arm lifting unit 130 and the left leg lifting unit 140 that are disposed in lower portion of the sub-frame 120.

The lower structure of the sub-frame 120 includes a block support 124 for supporting the center block 121, the right block 122 and the left block 123. The block support 124 is also a frame for supporting the blocks, and is configured to fix and support the right arm lifting unit 130, the left leg lifting unit 140, and the side block lifting unit 150.

The central shaft 125 of the sub-frame is configured to correspond to the length of the center block 121 in the longitudinal direction thereof, and is configured to be inserted into the sub-frame 120 while passing through the center of the sub-frame 120, that is, the center of the center block 121. Since the central shaft 125 and the sub-frame 120 are integrated with each other, the sub-frame 120 is also rotated when the central shaft 125 is rotated. Both ends of the central shaft 125 may be supported by the main frame 110, and may be rotated by the following sub-frame tilting unit 160.

Next, the configuration of the right arm lifting unit 130 is described in greater detail with reference to FIG. 3.

The right arm lifting unit 130 includes a first circular rotator 131, a first driving motor 132, and a first connecting member 133.

The first circular rotator 131 includes two circular plates 131a and 131b disposed in parallel with each other, and a plurality of plate connecting members 131c configured to be disposed between the two circular plates 131a and 131b and to then connect the circular plates 131a and 131b. The plate connecting member 131c may be connected in order to vertically intersect the planes of the two circular plates 131a and 131b. In this case, since the curved surfaces of the circular plates 131a and 131b come into contact with the right arm lifting block 121a and then selectively raise and lower the right arm lifting block 121a, the right arm lifting block 121a may be selectively raised and lowered in a more balanced manner because the two circular plates 131a and 131b are used instead of a single circular plate.

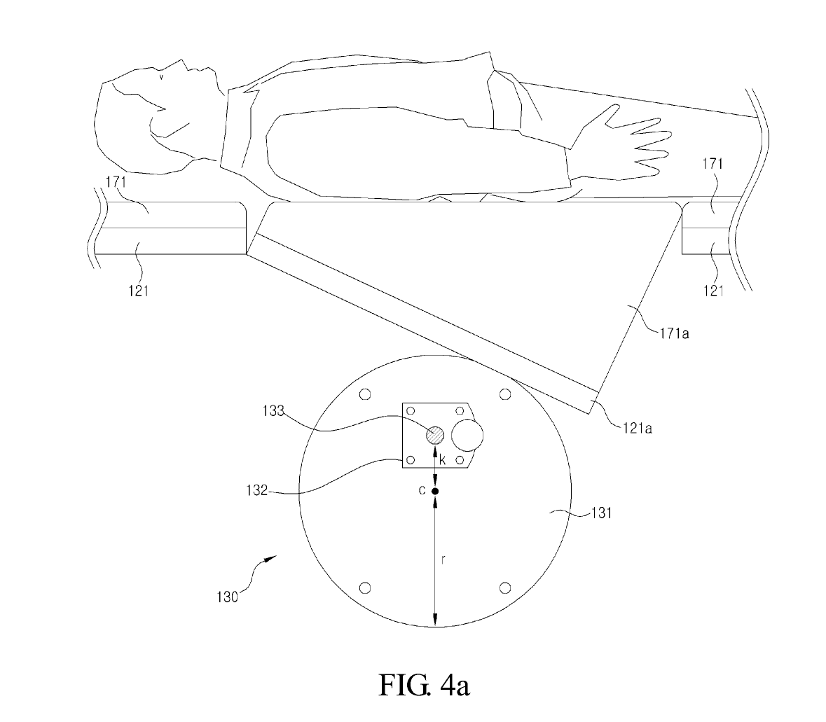

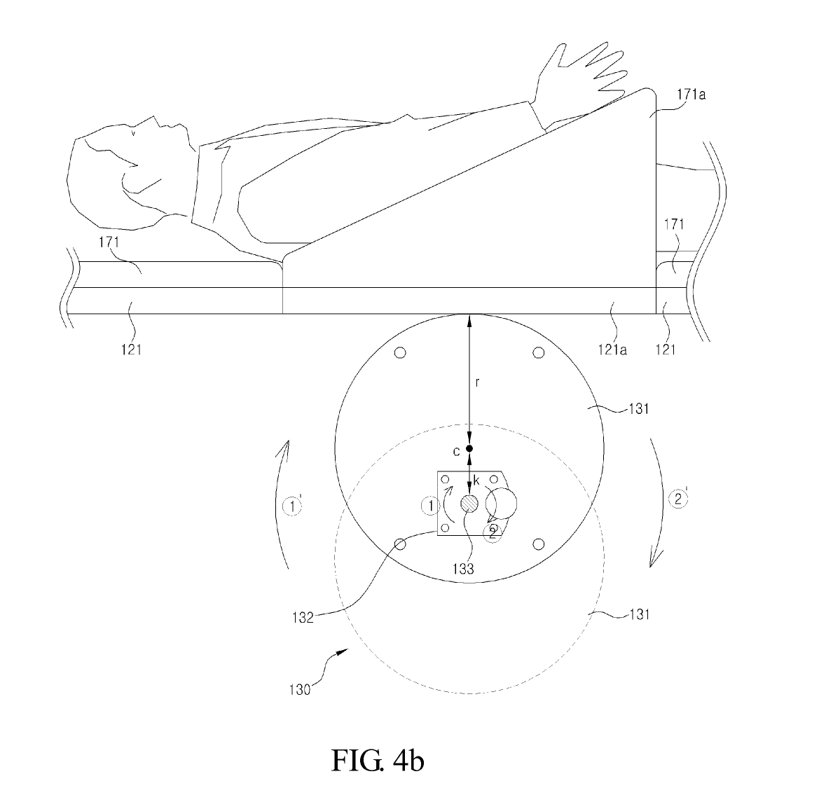

The first connecting member 133 is configured to connect the first circular rotator 131 and the first driving motor 132, and functions as an axis of rotation that rotates in place. A portion to which the first connecting member 133 and the first circular rotator 131 are connected corresponds to an noncentral region that is a predetermined distance away from the center of the first circular rotator 131. Referring to FIG. 4A, the first connecting member 133 may be fixed to the noncentral region that is distance “k” away from the center c of the first circular rotator 131 having a radius of “r.”

The first driving motor 132 may rotate the first circular rotator 131 by rotating the first connecting member 133. The first driving motor 132 may be supported and fixed by a region of the block support 124 of the sub-frame 120.

The operation of the right arm lifting unit 130 is described in greater detail below with reference to FIGS. 4A and 4B.

FIG. 4A is a side view illustrating the case where the first circular rotator 131 is disposed at an initial location when the right arm lifting unit 130 does not operate. The curved surface of the first circular rotator 131 of the right arm lifting unit 130 is disposed to come into contact with the right arm lifting block 121a. In this case, a right arm mattress 171a attached to the top of the right arm lifting block 121a may be formed to be thicker than another mattress 170. Specifically, the right arm mattress 171a may be formed to have a triangular sectional shape, and may thus have differences in height. In this case, a mattress area corresponding to a hand of the patient may be configured to be higher than a mattress area corresponding to the shoulders of the patient. In this case, since the right arm lifting block 121a has been lowered, the right arm of the patient placed on the right mattress 171a is also disposed at a location that is even with the surface of another mattress 170. In this case, the distance between the right arm lifting block 121a and the first connecting member 133 is about “r−k.”

FIG. 4B is a side view illustrating the case where the right arm lifting unit 130 operates and then the right arm of the patient is raised. The first connecting member 133 is rotated in place at a first angle in direction \textcircled{1} by the first driving motor 132, and thus the first circular rotator 131 is also rotated in direction \textcircled{1}′ and raised. Accordingly, the right arm lifting block 121a that comes into contact with the curved surface of the first circular rotator 131 is raised, and thus the right arm of the patient is raised higher than the face of the patient by a difference in height between the right arm mattress 171a and another mattress 170. In this case, the distance between the first connecting member 133 and the right arm mattress 171a is “r+k.” That is, a rotation range formed by the first circular rotator 131 is a circular area having a maximum radius of “r+k” around the axis of rotation.

Further, if the first connecting member 133 is rotated in place at a second angle in direction \textcircled{2}, the first circular rotator 131 is rotated in direction \textcircled{2}′ and moved, and is then returned to the same initial location, as illustrated in FIG. 4A.

That is, when the location of the first connecting member 133 (that is, the axis of rotation) is the center c of the first circular rotator 131 and the first circular rotator 131 has been rotated, the maximum and minimum rotation ranges of the first circular rotator 131 correspond to a circular area having a radius of “r” around the axis of rotation, which is always the same. However, in accordance with an embodiment of the present invention, since the location of the first connecting member 133 is connected to the noncentral region that is distance “k” away from the center c, the maximum location at which the first circular rotator 131 may arrived through the rotation of the first circular rotator 131 becomes the location that is distance “r+k” away from the axis of rotation. In contrast, the minimum location at which the first circular rotator 131 may arrived becomes the location that is about distance “r−k” away from the axis of rotation. The right arm mattress 171a may be raised and lowered vertically depending on the characteristic of the rotation range of the first circular rotator 131.

Furthermore, an advantage arises in that a control processor may be simply implemented because the upward and downward operations of the right arm mattress 171a may be repeatedly controlled by continuously rotating the first circular rotator 131 only in a single direction and controlling only a rotation angle, as illustrated in FIG. 4B, based on the structure characteristic of this right arm lifting unit 130.

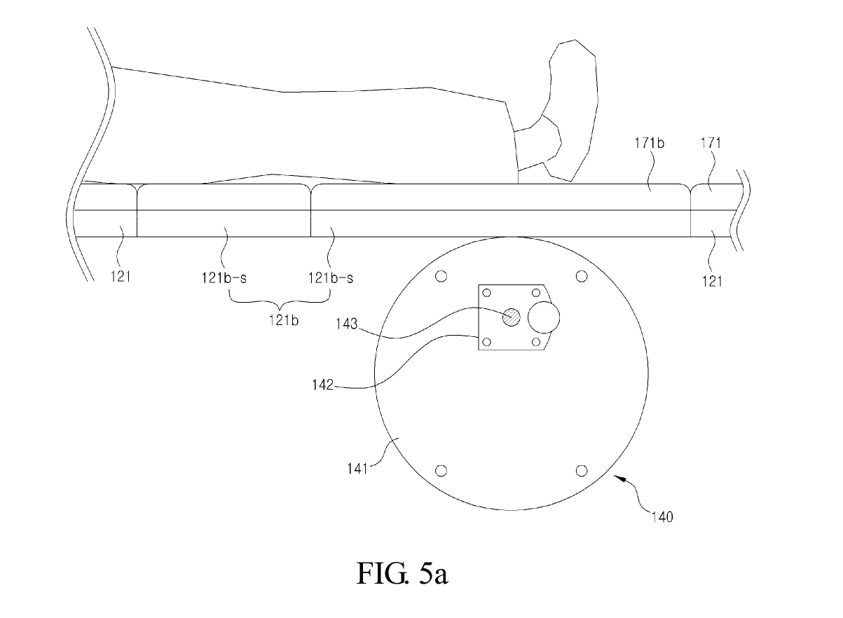

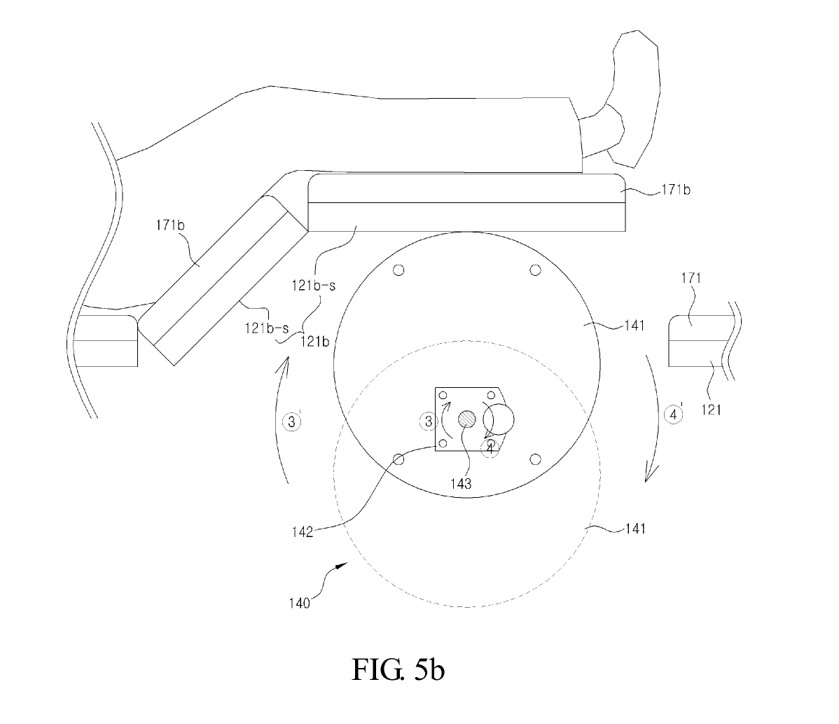

The operation of the left leg lifting unit 1404 is described in greater detail below with reference to FIGS. 5A and 5B. The structure of the left leg lifting unit 140 may be configured in the same structure as the right arm lifting unit 130 described with reference to FIG. 3. Accordingly, a second circular rotator 141, a second driving motor 142 and a second connecting member 143 that constitute the left leg lifting unit 140 are configured in the same forms as the first circular rotator 131, the first driving motor 132, and the first connecting member 133, respectively. Accordingly, the second circular rotator 141, the second driving motor 142 and the second connecting member 143 may perform the same operations as the first circular rotator 131, the first driving motor 132, and the first connecting member 133, respectively.

FIG. 5A is a diagram illustrating the initial state of the left leg lifting unit 140, and FIG. 5B is a diagram illustrating the state in which the left leg lifting unit 140 raises the left leg of the patient. Comparing the two diagrams, the operation of the left leg lifting unit 140 corresponds to the operation of the right arm lifting unit 130 described with reference to FIGS. 4A and 4B. That is, the second connecting member 143 is rotated in place at a third angle in direction \textcircled{3}, and thus the second circular rotator 141 is rotated in direction \textcircled{3}′ and moved, thereby raising the left leg of the patient. Further, the second connecting member 143 is rotated at a fourth angle in direction \textcircled{4} that is already the existing rotation direction, and thus the second circular rotator 141 is rotated in \textcircled{4}′ direction and moved, thereby being returned to the original location.

FIGS. 5A and 5B are different from FIGS. 4A and 4B in that the left leg lifting block 121b includes two sub blocks 121b-s connected in order to be bent with respect to each other and are then designed by taking into account the movement of the joint of the left leg of the patient. That is, since the sub blocks 121b-s are configured to correspond to the thigh and calf of the left leg, respectively, the sub blocks 121b-s are also bent in a form similar to the bent shape of the leg, and thus may more comfortably support the left leg of the patient when the second circular rotator 141 raises the two sub blocks 121b-s.

Meanwhile, the left leg lifting block 121b may include three or more sub blocks 121b-s. Since the two sub block 121b-s are configured to correspond to the thigh and calf length of the patient, the patient may feel comfortable only if the length of the two sub blocks 121b-s and the length of the body of the patient are similar. Accordingly, when the length of the left leg of the patient and the length of the left leg lifting block 121b are not the same, the patient may also feel inconvenience. In order to overcome this case, the left leg lifting block 121b may be connected such that the three or more sub blocks 121b-s may be bent with respect to each other. For example, when the three sub blocks are provided, the left leg lifting block 121b may be configured such that a lower sub block and the remaining sub blocks are bent with respect to each other if the left leg of the patient is long. In contrast, if the left leg of the patient is short, the left leg lifting block 121b may be configured such that an upper sub block and the remaining sub blocks are bent with respect to each other. Further, at least two of the three or more sub blocks 121b-s are set such that they are not bent based on the setting of the patient, and thus may be configured to be optimized for the patient having various body sizes. Furthermore, the left leg lifting unit 140 is installed on lines (for example, rails) along the sub-frame 120, which correspond to the left leg lifting block 121b, under the left leg lifting block 121b, and thus the left leg lifting unit 140 may be configured to move along the lines in order to control the location of the left leg lifting unit 140 according to the size of the body of the patient.

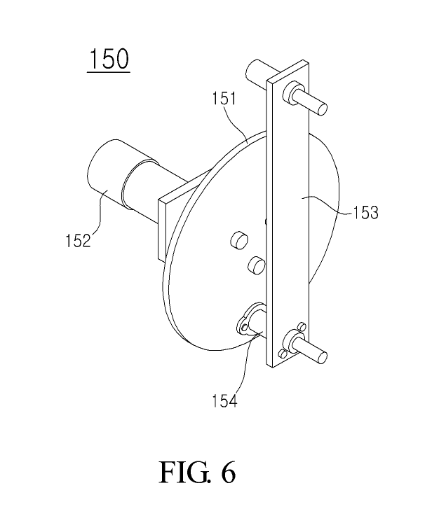

The side block lifting unit 150 according to an embodiment of the present invention is described in greater detail below with reference to FIG. 6.

The side block lifting unit 150 includes a third circular rotator 151, a third driving motor 152, a side block link 153, and a third connecting member 154.

The third circular rotator 151 is disposed to be spaced apart from the bottom of the right block 122, and may be formed of one circular plate unlike the first and second circular rotators 131 and 141. The third circular rotator 151 may be connected to the third driving motor 152 at the center thereof, and may be rotated in place by the operation of third driving motor 152. One end of the side block link 153 is connected to an noncentral region of the third circular rotator 151 by the third connecting member 154, and the other end of the side block link 153 is connected to the bottom of the right block 122 in order to support the bottom of the right block 122.

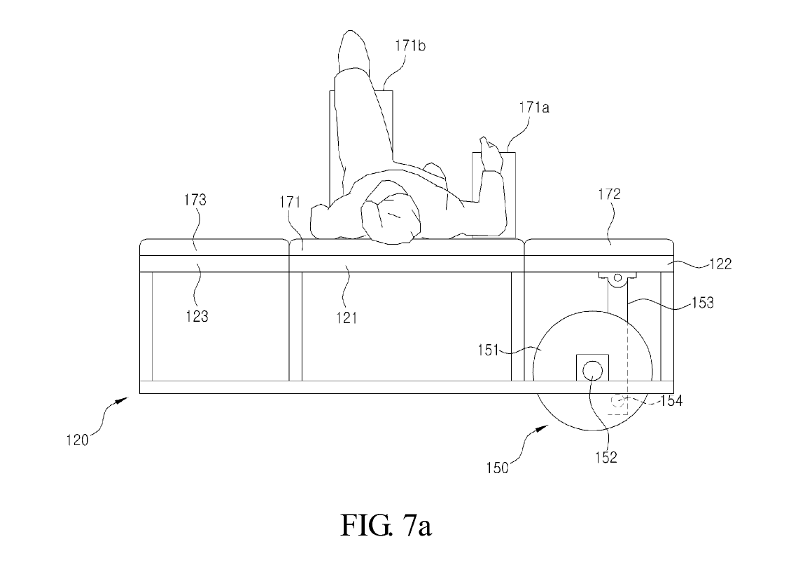

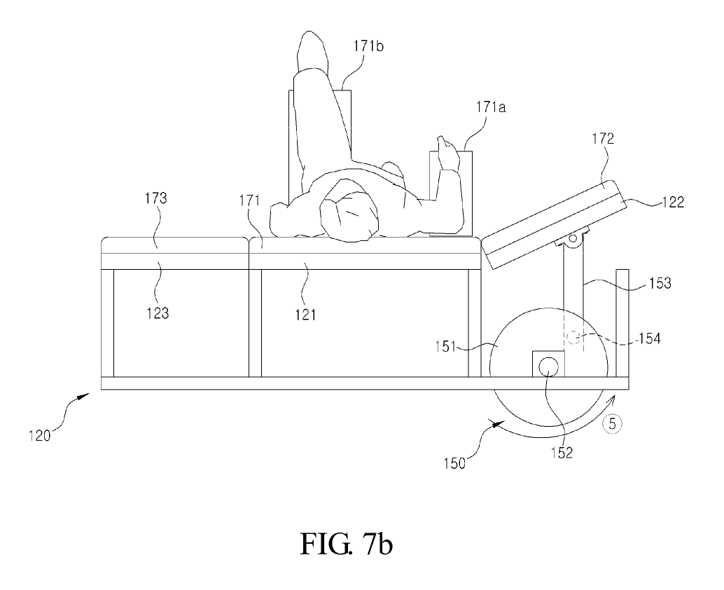

The operation of the side block lifting unit 150 is described in greater detail with reference to FIGS. 7A and 7B. It is noted that the right arm lifting unit 130 and the left leg lifting unit 140 are omitted in FIGS. 7A and 7B.

FIG. 7A illustrates an initial state before the operation of the side block lifting unit 150. In this case, the right arm and left leg of the patient are additionally raised in a position (a first position) in which the patient lies while looking at a ceiling. The side block lifting unit 150 is located in the lower part of the right block 122, and the third driving motor 152 is fixed and supported by the block support 124 of the sub-frame 120.

Referring to FIG. 7B, the third driving motor 152 rotates the third circular rotator 151 at a fifth angle in direction \textcircled{5} (for example, counterclockwise), and thus the side block link 153 is raised in an upward direction. Accordingly, the right block 122 connected to the top of the side block link 153 is raised and bent. In this case, since the right block 122 is connected with the center block 121, the right block 122 is bent upward at a predetermined angle with respect to a surface formed by the center block 121, and is then located. In this case, the angle at which the right block 122 is bent is an acute angle.

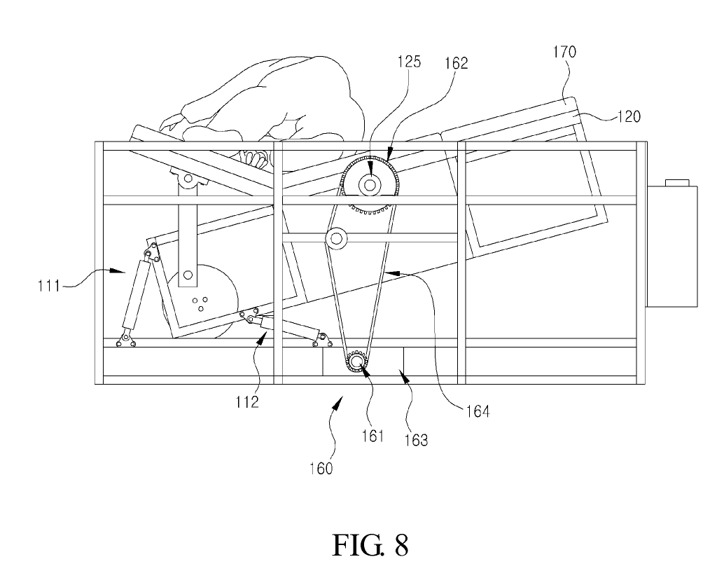

Furthermore, the sub-frame tilting unit 160 according to an embodiment of the present invention is described in greater detail with reference to FIG. 8.

The sub-frame tilting unit 160 tilts the sub-frame 120 from the state of FIG. 7B in one direction, and thus may change the position of the patient from a first position to a second position. More specifically, the sub-frame tilting unit 160 includes a first gear 161, a second gear 162, a first gear driving motor 163, and a chain 164. The first gear 161 and the second gear 162 are connected by the chain 164. The first gear 161 may be rotated in one direction by the first gear driving motor 163. Accordingly, the rotation of the first gear 161 in place may be transferred to the second gear 162 by the chain 164. Since the second gear 162 is connected to the central shaft 125 of the sub-frame 120, the rotation of the second gear 162 may result in the rotation of the central shaft 125. Accordingly, the sub-frame 120 may be disposed in order to be tilted in one direction.

Meanwhile, each of supporting members 111 and 112 is connected between the sub-frame 120 and the main frame 110, and thus the sub-frame 120 may be assisted in being tilted and fixed at a predetermined angle. The upper end of each of the supporting members 111 and 112 may be connected to the sub-frame 120, whereas the lower end of each of the supporting members 111 and 112 may be connected to the main frame 110. The supporting members 111 and 112 may include the first supporting member 111 and the second supporting member 112. As illustrated in FIG. 8, the first supporting member 111 may be connected to the side surface of the sub-frame 120, and the second supporting member 112 may be connected to the bottom of the sub-frame 120 and be connected with the sub-frame 120 by a hinge (not illustrated). Furthermore, at least one of two ends of each of the hinged first and second supporting members 111 and 112 is configured to be moved in the main frame 110 or the sub-frame 120, thereby supporting the tilting and returning operation of the sub-frame 120.

The sub-frame 120 is tilted such that the right block 122 bent upward may be disposed below the side block 123, in which case the body of the patient is tilted in the tilting direction of the sub-frame 120 and, thus, the position of the patient is changed from the first position to the second position. In this case, since the body of the patient is tilted while the right hand of the patient is raised, the right arm is not pushed by the body. Furthermore, since the body of the patient is tilted while the left leg of the patient is raised, the left leg is moved to an area where the side block is disposed and, thus, the pelvis of the patient may be stood in a direction perpendicular to the mattress 170. Furthermore, the raised right block 122 prevents the body of the patient from being moved out of the sub-frame 120. That is, by the operations of the right arm lifting unit 130, the left leg lifting unit 140, the side block lifting unit 150 and the sub-frame tilting unit 160, the body of the patient is changed from the first position to the second position. Furthermore, the body of the patient may be changed to the second position that is optimized for the patient.

Meanwhile, in accordance with an embodiment of the present invention, the side block lifting unit 150 may be disposed in the lower part of the right block 122 or the lower part of the left block 123. In this case, the sub-frame tilting unit 160 may tilt the sub-frame 120 so that the left block 123 is disposed below the right block 122. Furthermore, the right arm lifting unit 130 may be also changed to a left arm lifting unit, and then may be disposed at a location corresponding to the left arm. Furthermore, the left leg lifting unit 140 may be also changed to a right leg lifting unit, and then may be disposed at a location corresponding to the right leg.

Meanwhile, in accordance with an additional embodiment of the present invention, a bedsore treatment fan may be further included. The bedsore treatment fan is additionally installed in an area of the main frame 110, and is then applied to the back part of the body, such as the back, hips and thigh of the patient, when the patient has been changed to the second position, thereby treating a wound caused by bedsores.

Since bedsores are tissue damage that occurs due to the pressing of the skin for a long time, the most important thing of the prevention of bedsores is to change the portion of the body of the patient, to which pressure is applied, by changing the position of the patient within at least two hours. Accordingly, although the pressured portion of the body is changed in a position in which a patient is lying, it is difficult to fundamentally prevent bedsores. Therefore, an embodiment of the present invention is characterized by changing the position of the patient in order to prevent bedsores (changing the position in which the patient lies while looking at the ceiling to the position in which the patient lies while looking to the side). Furthermore, since the patient may change his or her position or return the position to an initial position, the patient may conveniently control the apparatus for preventing bedsores by himself or herself.

In accordance with at least one embodiment of the above-described present invention, bedsores which may occur in a patient can be prevented by changing the basic position of a patient.

In accordance with at least one embodiment of the above-described present invention, the lying position of a patient can be changed even by simple button manipulation.

Although the preferred embodiments of the present invention have been disclosed for illustrative purposes, those skilled in the art will appreciate that various modifications, additions and substitutions are possible without departing from the scope and spirit of the invention as disclosed in the accompanying claims.

What is claimed is:

1. An apparatus for preventing bedsores, comprising:
a sub-frame including;
a center block configured to include a right arm lifting block and a left leg lifting block that are installed, respectively, at locations corresponding to a right arm and left leg of a lying patient if a body of the lying patient is disposed;
a left block and a right block are connected in order to be bent from both side surfaces of the center block; and
a central shaft configured to correspond to a length of a center block in longitudinal directions and installed along a center of the center block;
a main frame configured to surround and support the sub-frame;
a right arm lifting unit supported by the sub-frame below the right arm lifting block, the right arm lifting unit including;
a first circular rotator disposed to come into contact with a bottom of the right arm lifting block;
a first connecting member connected to an noncentral region of the first circular rotator that is away from a center of a circle of the first circular rotator; and
a first driving motor configured to rotate the first connecting member in place so that the first circular rotator pushes and raises the right arm lifting block and, thus, the right arm lifting block is protruded above a top of the center block;
a left leg lifting unit supported below the left leg lifting block by the sub-frame, the left leg lifting unit including;
a second circular rotator disposed to come into contact with a bottom of the left leg lifting block;
a second connecting member connected to an noncentral region of the second circular rotator that is away from the center of the circle of the second circular rotator; and
a second driving motor configured to rotate the second connecting member in place so that the second circular rotator pushes and raises the left leg lifting block and, thus, the left leg lifting block is protruded above the top of the center block;
a side block lifting unit supported below the right block by the sub-frame, the side block lifting unit including;
a third circular rotator disposed to be spaced apart from a bottom of the right block;
a side block link configured such that one end thereof is connected to an noncentral region of the third circular rotator that is away from a center of a circle of the third circular rotator and the other end thereof is connected to a bottom of the right block; and
a third driving motor configured to rotate the third circular rotator in place so that the side block link pushes and raises the right block and, thus, the right block is bent at a predetermined angle toward the center block; and
a sub-frame tilting unit including;
a first gear installed in a lower portion of the main frame;
a second gear installed in an upper portion of the main frame and connected with the central shaft of the sub-frame;
a chain configured to connect the first and second gears so that rotation of the first gear in place causes rotation of the second gear in place; and
a first gear driving motor configured to rotate the first gear in place so that the second gear tilts the sub-frame, which supports the pushed and raised right arm lifting block, the left leg lifting block and the right block, at a predetermined angle in such a manner that the second gear rotates the central shaft of the sub-frame at a predetermined angle.

2. The apparatus of claim 1, wherein the first driving motor:
rotates the first connecting member in place at a first angle in one direction so that the first circular rotator moves upward while rotating and, thus, pushes and raises the right arm lifting block; and
rotates the first connecting member in place at a second angle in the one direction so that first circular rotator that has pushed and raised the right arm lifting block moves downward while rotating and, thus, returns to an initial location.

3. The apparatus of claim 1, wherein the second driving motor:
rotates the second connecting member in place at a third angle in one direction so that the second circular rotator moves upward while rotating and, thus, pushes and raises the left leg lifting block; and
rotates the second connecting member in place at a fourth angle in the one direction so that the second circular rotator that has pushed and raised the left leg lifting block moves downward while rotating and, thus, returns to an initial location.

4. The apparatus of claim 1, wherein each of the first and second circular rotators comprises:
a plurality of circular plates spaced apart from each other and disposed in parallel with each other; and
a plurality of plate connecting members configured to connect a plurality of circular plates.

5. The apparatus of claim 4, wherein the first and second circular rotators are disposed such that a curved surface of the plurality of circular plates comes into contact with the bottom of the left leg lifting block or the bottom of the right arm lifting block.

6. The apparatus of claim 1, wherein:
the apparatus for preventing bedsores further comprises a right arm mattress attached to a top of the right arm lifting block; and
the right arm mattress is thicker than a mattress attached to a top of the center block exclusive of the right arm lifting block.

7. The apparatus of claim 6, wherein the right arm mattress has a difference in height so that a mattress area corresponding to a right hand of the lying patient is higher than a mattress area corresponding to a right shoulder of the lying patient.

8. The apparatus of claim 1, wherein:
the left leg lifting block comprises a plurality of sub blocks connected in order to be bent with respect to each other; and
the plurality of sub blocks are connected in order to be bent with respect to each other at a predetermined angle when being pushed and raised upward by the second circular rotator.

9. The apparatus of claim 8, wherein the left leg lifting unit is installed in the sub-frame in order to be moved along lines corresponding the left leg lifting block.

10. The apparatus of claim 1, wherein the side block lifting unit is configured to push and raise the right block so that an angle at which the right block is bent is an acute angle.

11. The apparatus of claim 10, wherein the sub-frame tilting unit is configured to tilt the sub-frame so that the right block is lowered below the left block.

12. The apparatus of claim 1, further comprising a supporting member configured such that an upper end thereof is connected with the sub-frame and a lower end thereof is connected with the main frame so that the sub-frame is assisted in being tilted and fixed at a predetermined angle.
